(19) United States
(12) Patent Application Publication
(10) Pub. No.: US 2025/0368544 A1
(43) Pub. Date: Dec. 4, 2025

(54) WATER PURIFIER AND WATER PURIFIER ASSEMBLY COMPRISING SAME

(71) Applicant: COWAY CO., LTD., Gongju-si (KR)

(72) Inventors: Hee Joo KANG, Seoul (KR); Hyun Kang LEE, Seoul (KR); Jong Hwan LEE, Seoul (KR); Yoo Won OH, Seoul (KR); Hyun Goo KIM, Seoul (KR); Da Woon JUNG, Seoul (KR); Hee Do JUNG, Seoul (KR); Chan Jung PARK, Seoul (KR); Dong Min OH, Seoul (KR); Byung Hyo YE, Seoul (KR); Seong Min PARK, Seoul (KR); Seung Won LEE, Seoul (KR)

(73) Assignee: COWAY CO., LTD., Gongju-si (KR)

(21) Appl. No.: 18/871,038

(22) PCT Filed: May 15, 2023
(86) PCT No.: PCT/KR2023/006535

§ 371 Date: Dec. 2, 2024

(30) Foreign Application Priority Data
Jun. 3, 2022 (KR) 10-2022-0068556

(51) Int. Cl. C02F 1/00; C02F 1/02

(52) U.S. Cl. CPC C02F 1/003; C02F 1/02; C02F 2201/004; C02F 2201/005; C02F 2307/10

(57) ABSTRACT

A water purifier includes: a frame configured to accommodate a filter for filtering water; a flow path module providing a passage for the water to flow and disposed at an upper portion in the frame; a valve module selectively opened and closed to control the flow of water in the flow path module and disposed at a position adjacent to the flow path module; and a substrate assembly for controlling an opening and closing of the valve module. The substrate assembly includes: at least one substrate electrically connected to the valve module; and a substrate support covering at least a portion of the substrate and coupled to the frame to support the at least one substrate. The substrate support is disposed below the flow path module and the valve module and supports at least one of the flow path module and the valve module.

### TECHNICAL FIELD

The present disclosure relates to a water purifier, and a water purifier assembly including the same.

### BACKGROUND ART

In general, a water purifier is a ice that receives water from a source such as a tap, filters the water into purified water through a filter provided the rein, and then provides the purified water to a user. In addition, the water purifier may provide purified water directly to the user, but may also cool purified water to a predetermined temperature or below using a cooler and provide it as cold water, or heat purified water to a preset temperature or above using a heater and provide hot water to the user.

The case of the water purifier is subjected to a load due to the weight of the components of the water purifier, such as the filter, cooler, and heater described above. During the of manufacturing and transporting the water purifier to a consumer, the water purifier is subjected to a greater load due to drop of the water purifier, shipment or other factors, which may cause the case to lose its shape or be damaged.

Conventionally, the issues of deformation of the water purifier case and the risk of detachment of the components are not recognized.

For example, in Korean Patent Application rub cation No. 10-2022-0046953 entitled “Water purifier” of the present applicant, in cases where the components of the water purifier, such as the filter, heater, and pipes are designed to be placed at the upper side in the water purifier, the case of the water purifier is subjected to a greater load, which increases the risk of deformation and damage to the case described above. Furthermore, if the water purifier is subjected to a large load, such as during transportation, there is a risk that the components of the water purifier may not remain in place and could become dislodged.

### DETAILED DESCRIPTION OF INVENTION

### Technical Problems

One embodiment of the present disclosure provides a water purifier in which a frame supports internal components of the water purifier, thereby preventing deformation of the frame and allowing the components of the water purifier to remain in place even when subjected to loads.

### Technical Solution

A water purifier according to an aspect of the present disclosure includes: a frame configured to accommodate a filter for filtering water; a flow path module providing a passage for the water to flow and disposed at an upper portion in the frame; a valve module selectively opened and closed to control the flow of water in the flow path module and disposed at a position adjacent to the flow path module; and a substrate assembly for controlling an opening and closing of the valve module, wherein the substrate assembly includes: at least one substrate electrically connected to the valve module; and a substrate support covering at least a portion of the substrate and coupled to the frame to support the at least one substrate, and wherein the substrate support is disposed below the flow path module and the valve module and supports at least one of the flow path module and the valve module.

Further, the water purifier may further include a water body into which the water is introduced, and the flow path module, the valve module, and the substrate assembly may be disposed forward of the water body.

Further, the frame may include a filter frame in which the filter is installed and which supports at least one of the flow path module and the valve module, and the substrate support may support the filter frame and may be positioned below the filter frame.

Further, the filter frame may include: a frame body in which the filter is installed; and a supporter extending forward from the frame body and supporting at least one of the flow path module and the valve module.

Further, the substrate support may include a coupling part which is coupled to the filter frame, the coupling part may be provided at an upper portion of the substrate support, and the filter frame may include a fixing part provided to surround an upper surface and side surfaces of the coupling part when the coupling part is coupled to the filter frame.

Further, the frame may include a base frame which has an engaged part formed to be engaged with the substrate support and supports the substrate support, the substrate support may include an engaging part which selectively engages with the engaged part, the engaging part is provided at a lower portion of the substrate support, and the engaged part and the engaging part may be provided in a hook and groove shape so that one of them is selectively engaged with the other.

Further, the water purifier may further include; a heating device for heating the water to a predetermined temperature, wherein the at least one substrate includes: a first substrate electrically connected to the valve module; and a second substrate electrically connected to the heating device

Further, a width of the substrate assembly in a left and right direction may be greater than a width of the substrate assembly in a front and rear direction.

A water purifier assembly according to another aspect of the present disclosure includes: a filter for filtering water to provide purified water; and a water purifier in which the filter is detachably installed, wherein the water purifier includes: a frame configured to accommodate the filter; a flow path module providing a passage for the water to flow and disposed at an upper portion in the frame; a valve module selectively opened and closed to control the flow of water in the flow path module and disposed at a position adjacent to the flow path module; and a substrate assembly for controlling an opening and closing of the valve module, wherein the substrate assembly includes: at least one substrate electrically connected to the valve module; and a substrate support covering at least a portion of the substrate and coupled to the frame to support the at least one substrate, and wherein the substrate support is disposed below the flow path module and the valve module and supports at least one of the flow path module and the valve module.

Further, the frame may include a filter frame in which the filter is installed and which supports at least one of the flow path module and the valve module, and wherein the substrate support supports the filter frame.

### Effect of Invention

According to one embodiment of the present disclosure, the frame supports the internal components of the water purifier, so that deformation of the frame can be prevented and the components of the water purifier can remain in place even when subjected to loads.

### BRIEF DESCRIPTION OF THE DRAWINGS

FIG. 1 is a perspective view of a water purifier according to one embodiment of the present disclosure.

FIG. 2 is an exploded perspective view of the water purifier in FIG. 1.

FIG. 3 is a side cross sectional view showing a water body of the water purifier in FIG. 2.

FIG. 4 is a cross sectional view of the water purifier in FIG. 1 taken along line IV-IV.

FIG. 5 is a perspective view showing engagement of a filter frame and a substrate assembly of the water purifier in FIG. 1.

FIG. 6 is a perspective view showing disengagement of the filter frame and the substrate assembly of FIG. 5.

FIG. 7 is a rear perspective view of the substrate assembly of the water purifier in FIG. 1.

FIG. 8 is a side cross sectional view showing engagement of a base frame and the substrate assembly in FIG. 1.

### BEST MODE FOR CARRYING OUT THE INVENTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, ‘accessed’ to, ‘supplied’ to, ‘transferred’ to, or ‘contacted’ with another element, it should be understood that the element may be directly connected to, supported by, accessed to, supplied to, transferred to, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a water purifier assembly 1 according to one embodiment of the present disclosure will be described with reference to the drawings.

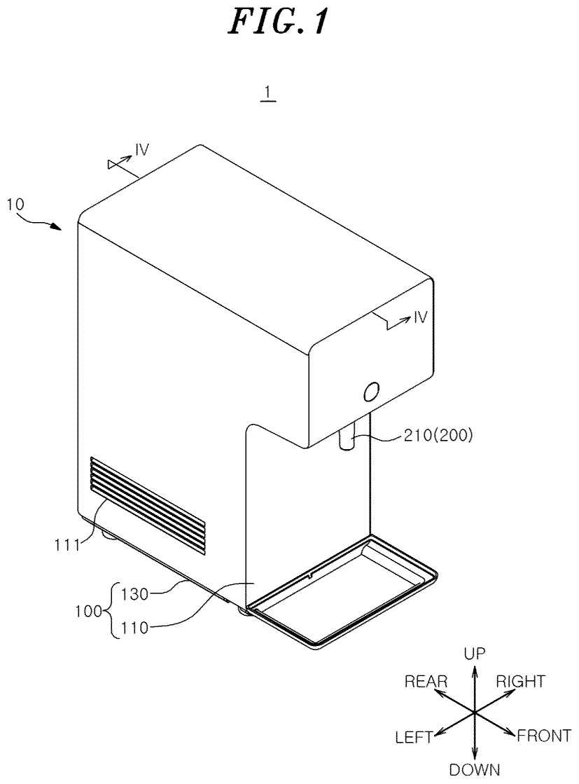

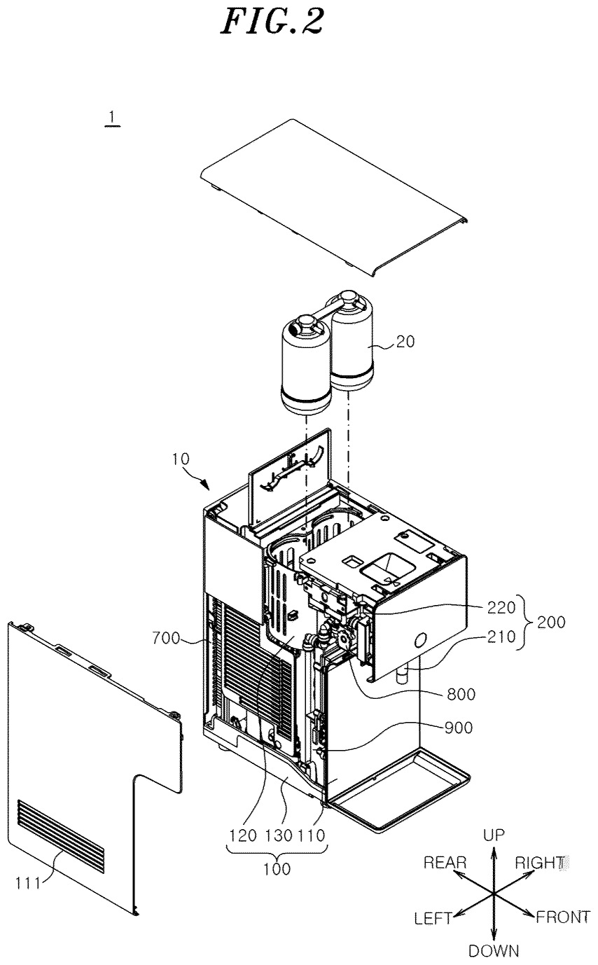

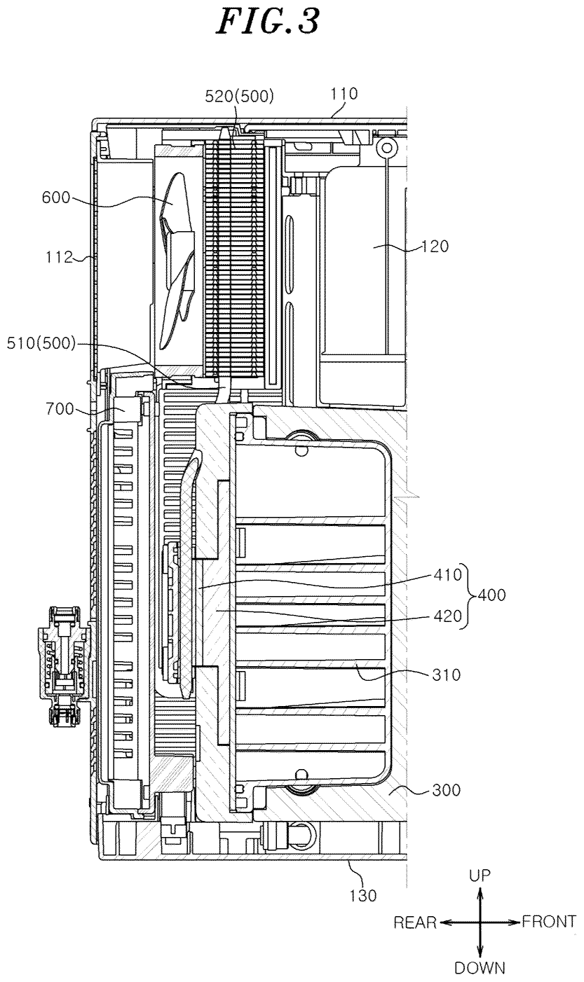

Referring to FIGS. 1 to 3, the water purifier assembly 1 according to one embodiment of the present disclosure can provide clean water to a user by filtering water supplied from an external source. In addition, the water purifier assembly 1 can cool the water to provide cold water to the user. The water purifier assembly 1 may include a water purifier 10, and a filter 20 installed in the water purifier 10 to filter raw water and provide purified water.

The water purifier 10 can filter water and provide clean water to the user when the filter 20 is mounted on the water purifier 10. The water purifier 10 may include a flow path module 200, a water body 300, a cooling unit 400, a heat dissipation unit 500, a fan unit 600, a power supply device 700, a valve module 800, and a substrate assembly 900.

A frame 100 may support one or more of the flow path module 200, the water body 300, the cooling unit 400, the heat dissipation unit 500, the fan unit 600, the power supply device 700, the valve module 800, and the substrate assembly 900. The frame 100 may include a main frame 110, a filter frame 120, and a base frame 130.

The main frame 110 may have an open bottom to provide a space for accommodating one or more of the flow path module 200, the water body 300, the cooling unit 400, the heat dissipation unit 500, the fan unit 600, the power supply device 700, the valve module 800, and the substrate assembly 900. In addition, the main frame 110 may include a housing that forms the exterior of the water purifier 10.

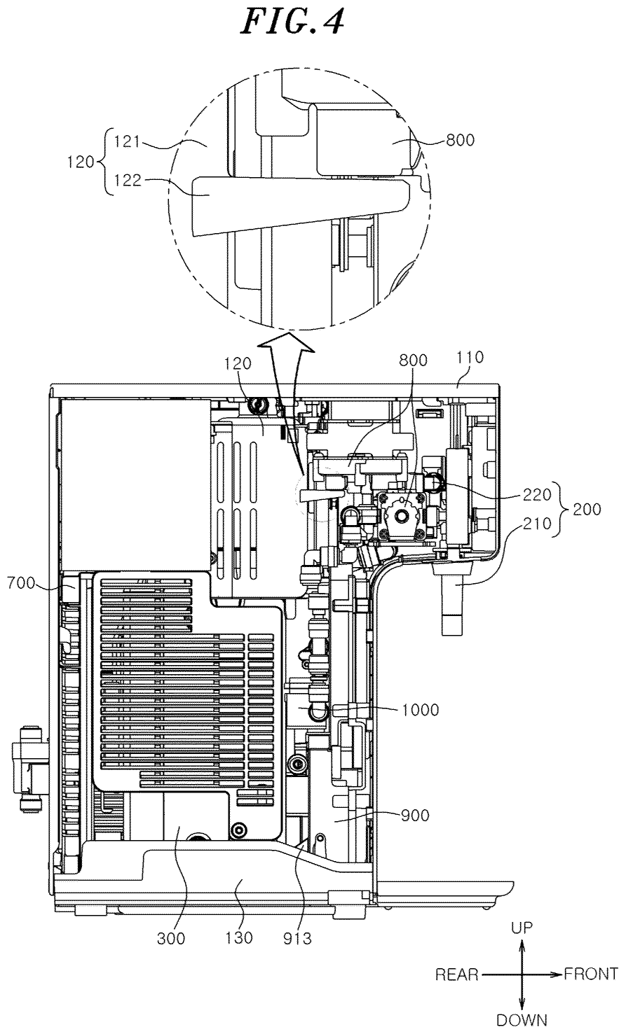

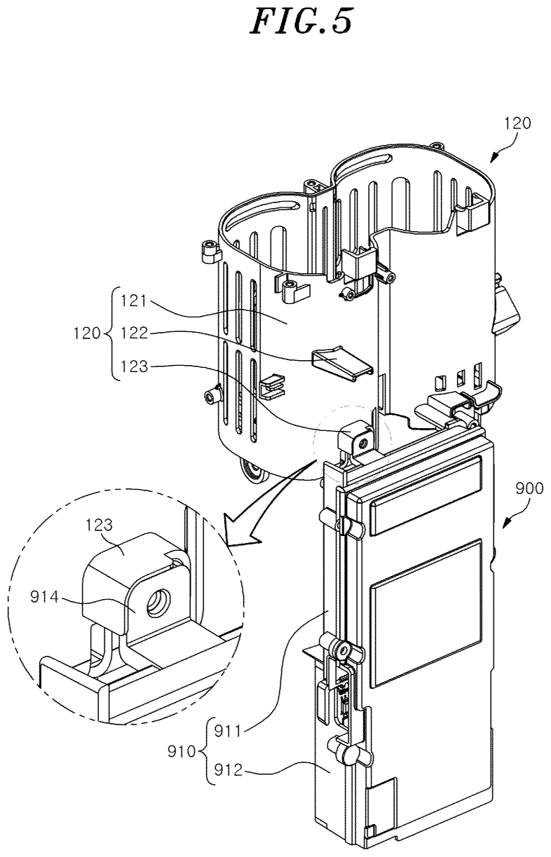

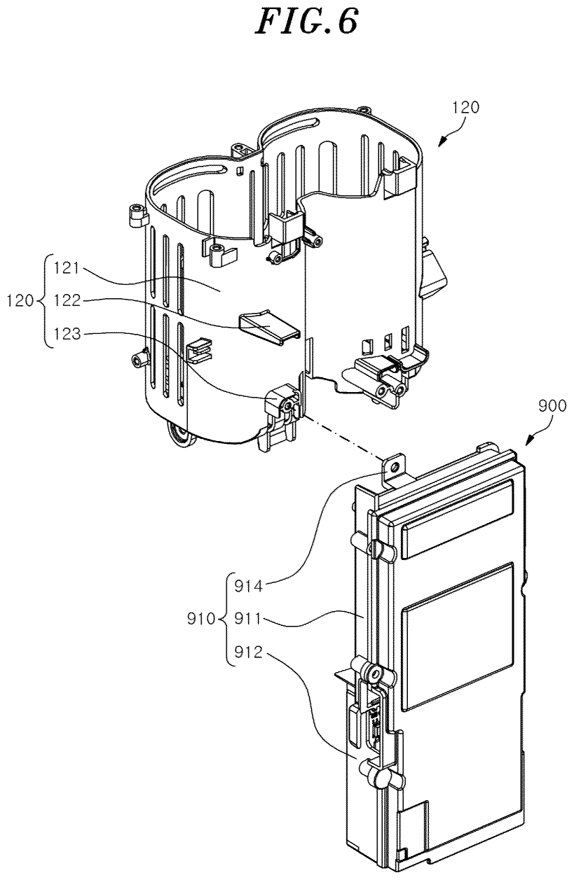

Referring further to FIGS. 4 to 6, the filter frame 120 may have one side open to accommodate the filter 20. The filter frame 120 may be disposed at a rear and upper portion in the water purifier 10 and may be configured to be open at the top. The filter frame 120 may be disposed in the main frame 110 to be located at the front side of the fan unit 600 and at the rear side of the flow path module 200, and may be supported by the main frame 110. The filter frame 120 may include a frame body 121, a supporter 122, and a fixing part 123.

The frame body 121 may provide a filter receiving portion (filter receiving space) in which the filter 20 can be received and installed. A plurality of through holes may be formed in a side surface of the frame body 121 to allow air to flow in and out of the frame body 121. The through holes may be formed in the filter frame 120 to allow air to flow through the filter frame 120. For example, air introduced into the frame 100 may flow through the through-holes of the filter frame 120 to the heat sink 520. A plurality of through-holes may be provided.

The supporter 122 may support at least one of the flow path module 200 and the valve module 800. The supporter 122 may be disposed on a front side of the frame body 121 and may have a shape protruding from the frame body 121. The supporter 122 may be disposed below the flow path module 200 and the valve module 800.

The fixing part 123 can fix the substrate assembly 900. The fixing part 123 may be formed in a groove shape, and may be coupled to the substrate assembly 900 by a coupling part 914 of the substrate assembly 900, which will be described later, being inserted therein. In addition, the fixing part 123 may be configured to surround an upper surface and a side surface of the coupling part 914 to be described later. The fixing part 123 may be formed on the front side of the frame body 121 and may be positioned below the supporter 122. In addition, a screw hole may be formed in the fixing part 123 so that the fixing part 123 can be screw-coupled with the substrate assembly 900. A plurality of fixing parts 123 may be provided. For example, when the filter frame 120 is provided with two filter receiving portions to accommodate two filters as shown in the drawings according to the present embodiment, the fixing part 123 may be provided in each of a first filter receiving portion where a first filter is accommodated and a second filter receiving portion where a second filter is accommodated.

The base frame 130 may be provided on the lower side of the main frame 110. In addition, the base frame 130 may provide a condensed water receiving space for receiving condensed water generated by the water body 300. The base frame 130 may be configured to support the water body 300. An engagement part 131 may be formed at the front side of the base frame 130 to engage with the substrate assembly 900. The engagement part 131 may have a hook or groove shape.

The flow path module 200 can guide water filtered by the filter 20 to the outside of the frame 100. The flow path module 200 may be supported by the main frame 110 to be positioned forward of the water body 300 at the front side in the main frame 110. The flow path module 200 may be detachably mounted on the main frame 110 to be replaceable from the main frame 110. The flow path module 200 may include a water dispensing part 210 and a flow path part 220.

The water dispensing part 210 can discharge water flowing along the flow path part 220 to the outside. The water dispensing part 210 may be disposed at the front side in the main frame 110, and at least a portion thereof may be exposed to the outside of the frame 100. In addition, the water dispensing part 210 may be in communication with the flow path part 220. Meanwhile, in the present specification, the water dispensing part 210 has been described as a single configuration with the flow path part 220, but this is merely an example, and the water dispensing part 210 may be provided as a separate configuration from the flow path part 220, and may also be formed integrally with the frame 100.

The flow path part 220 may provide a passage for water to flow. The flow path part 220 may guide water filtered by the filter 20 to the water dispensing part 210. In addition, the flow path part 220 may be disposed at the front side in the main frame 110 and may be disposed above the water dispensing part 210.

The water body 300 may provide a space for water to flow. For example, the water body 300 may be configured as a direct flow system that provides a path for water to flow. In this case, the water body 300 is provided with a plurality of partitions 310 that are alternately arranged, and a path for water to flow may be formed by the plurality of partitions 310. In addition, water introduced from an upper portion of the water body 300 may be discharged through a lower portion of the water body 300. Meanwhile, the flow direction of water flowing along the path formed inside the water body 300 may be changed a plurality of times by the plurality of partitions 310. Further, water introduced into the water body 300 can be cooled by the cooling unit 400 while flowing along the plurality of partitions 310.

However, the idea of the present disclosure is not necessarily limited to the above, and as another example, the water body 300 may be a reservoir type water tank capable of containing water. In this case, the water body 300 may provide a space for containing the introduced water, and a space for containing cold water cooled by the cooling unit 400. For example, the water contained in the water body 300 may rise from the bottom to the top of the water body 300 as water flows into the water body 300. The water introduced in the water body 300 can be cooled by the cooling unit 400 as it fills up.

As another example, the water body 300 may have a pipe shape (not shown) that allows the first-in water to be first discharged. In this case, water flowing along the pipe can be cooled by the cooling unit 400. In addition, water introduced into the pipe of the water body 300 can be cooled to a low temperature while flowing along the pipe and then discharged from the pipe.

The cooling unit 400 can cool water introduced in the water body 300 to a predetermined temperature or below. The cooling unit 400 may be supported on the water body 300 so that one surface thereof contacts the outer surface of the water body 300. In addition, the cooling unit 400 may be supported on the rear side of the water body 300. For example, the cooling unit 400 may be supported on the water body 300 such that a front surface thereof contacts a rear surface of the water body 300. Further, the cooling unit 400 may receive power from the power supply device 700, and the power transmitted to the cooling unit 400 may be controlled by the power supply device 700.

In addition, the cooling unit 400 may be configured as an electronic cooling device, which eliminates the need for a cooling system such as an evaporator or compressor, and allows the cooling unit 400 to cool water with minimal volume. The cooling unit 400 may include a thermoelectric module 410 and a cold block 420.

The thermoelectric module 410 can be cooled on one side and heated on the other side when current flows through it. A front surface of the thermoelectric module 410 may be in contact with a rear surface of the cold block 420. For example, when the front surface of the thermoelectric module 410 is cooled, cold generated in the thermoelectric module 410 is transferred to the rear surface of the water body 300 through the cold block 420. A rear surface of the thermoelectric module 410 may be in contact with a heat pipe 510 to be described later, and heat generated in the thermoelectric module 410 may be transferred to the heat pipe 510.

The cold block 420 can transfer the cold generated in the thermoelectric module 410 to the water body 300. The cold block 420 may be supported on the water body 300 such that a front side thereof contacts the rear surface of the water body 300. In addition, the cold block 420 may support the thermoelectric module 410 such that the rear surface thereof contacts the front surface of the thermoelectric module 410. The cold generated in the thermoelectric module 410 can be transferred to the water inside the water body 300 through the cold block 420. For example, the cold block 420 may be formed of a material with high thermal conductivity. In addition, the cold block 420 may be directly adhered to the water body 300, or may be coupled to the water body 300 by a fixing member such as a screw.

The heat dissipation unit 500 can release heat generated in the thermoelectric module 410 to the outside to prevent the cooling efficiency of the thermoelectric module 410 from decreasing. The heat dissipation unit 500 may include a heat pipe 510 and a heat sink 520.

The heat pipe 510 is disposed at the rear of the thermoelectric module 410 and can transfer heat generated in the thermoelectric module 410 to the heat sink 520. For example, the heat pipe 510 can receive heat from the thermoelectric module 410 through a heat conductor and transfer the received heat to the heat sink 520. The heat pipe 510 may be formed of a material having high thermal conductivity and may be provided in a plurality.

The heat sink 520 can release heat transferred from the heat pipe 510 to the outside. The heat sink 520 may be disposed on the upper side of the water body 300 and may be spaced apart upward from the water body 300. The heat sink 520 is placed on the upper side of the heat pipe 510 and connected to the heat pipe 510, and can receive heat from the heat pipe 510.

The fan unit 600 can cause air to flow so that external air of the frame 100 is drawn into the interior of the frame 100 and air drawn into the interior of the frame 100 is discharged to the outside of the frame 100. For example, when the fan unit 600 is operated, external air can be drawn into the interior of the frame 100 through an inlet 111, and air drawn into the interior of the frame 100 can be discharged to the outside of the frame 100 through an outlet 112.

In addition, the fan unit 600 can provide blowing force to cause air to flow to the heat sink 520. When heat is generated in the heat sink 520, the fan unit 600 can cool the heat sink 520 by causing air to flow to the heat sink 520. In addition, the fan unit 600 may be disposed on the rear side of the heat sink 520. The fan unit 600 may be adjustable in intensity based on operation of the thermoelectric module 410.

The power supply device 700 can supply power to the thermoelectric module 410 and the fan unit 600. The power supply device 700 may be electrically connected to the thermoelectric module 410 and the fan unit 600. For example, the power supply device 700 may be a switched mode power supply (SMPS). However, this is merely an example, and the power supply device 700 may be any known device that can supply power to the thermoelectric module 410 and the fan unit 600. In addition, the power supply device 700 may be disposed rearward of the water body 300 and at the rear side of the thermoelectric module 410. The power supply device 700 may be disposed at the rear side of the heat pipe 510 while being positioned below the heat sink 520. Further, the power supply device 700 may be disposed below the fan unit 600.

Meanwhile, the power supply device 700 may be disposed inside the frame 100 such that heat generated in the power supply device 700 is not transferred to water introduced in the frame 100. For example, the power supply device 700 may be disposed at the rear side in the frame 100 to be spaced apart from the water dispensing part 210. In this case, heat generated in the power supply device 700 can be prevented from being transferred to the water dispensing part 210. In addition, the power supply device 700 may be positioned inside the frame 100 at a certain distance behind the flow path part 220. In this case, heat generated in the power supply device 700 can be prevented from being transferred to water flowing along the flow path part 220. Further, the power supply device 700 may be positioned inside the frame 100 at a certain distance behind the filter frame 120. As a more detailed example, the power supply device 700 may be spaced farther rearward from the rear end of the filter frame 120 than the rear end of the water body 300 in a front and rear direction. In this case, heat generated in the power supply device 700 can be prevented from being transferred to the filter 20 installed in the filter frame 120.

The valve module 800 can open and close a flow path for one or more of purified water, cold water, and hot water. The valve module 800 may be connected to a plurality of inlet connectors and outlet connectors. In addition, the flow of purified water can be controlled by the operation of the valve module 800. The valve module 800 may be disposed forward of the water body 300.

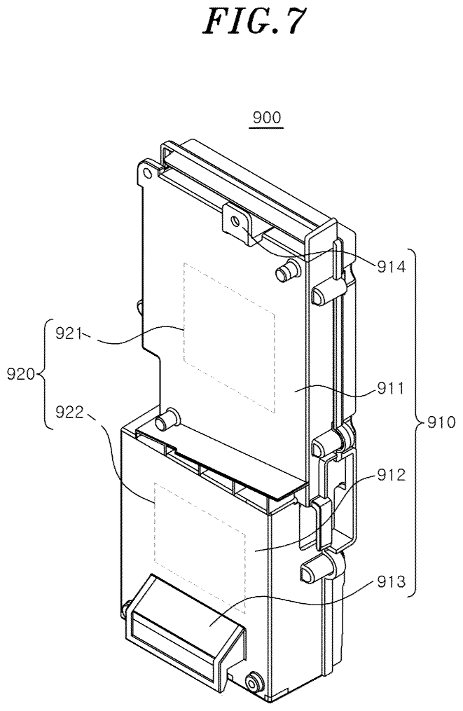

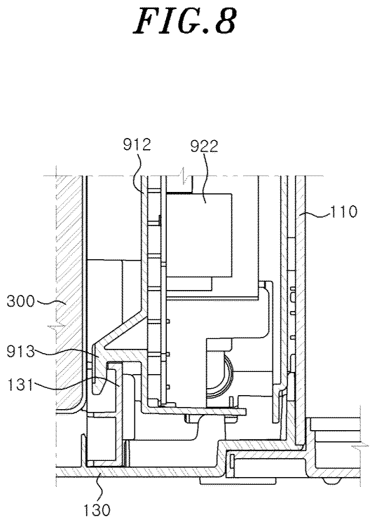

Referring further to FIGS. 7 and 8, the substrate assembly 900 may control one or more of the water body 300, the heat dissipation unit 500, the fan unit 600, the opening and closing of the valve module 800, the power supply device 700, and a heating device 1000. The substrate assembly 900 may be disposed forward of the water body 300 and rearward of the center of gravity of the flow path module 200 and the center of gravity of the valve module 800. In addition, a width in a left and right direction (a length in the left and right direction) of the substrate assembly 900 may be greater than a width in the front and rear direction (a length in the front and rear direction) of the substrate assembly 900. Further, a length in an up and down direction of the substrate assembly 900 may be greater than the width in the left and right direction. In other words, the substrate assembly 900 may be oriented so that its broad surface faces forward or rearward while standing upright in the up and down direction, and may be disposed parallel to the main frame 110 on the front side. The substrate assembly 900 may include a substrate support 910 and one or more substrates 920.

The substrate support 910 supports one or more substrates 920. The substrate support 910 may be formed of a plurality of frames, and one of the frames may have a rearwardly recessed groove to accommodate one or more substrates 920. The substrate support 910 may be configured to surround at least a portion of a surface of the substrate 920 to prevent water from entering the substrate 920. In other words, the substrate support 910 may cover one or more of a front surface, a rear surface, an upper surface, a lower surface, and both side surfaces of the substrate 920. For example, the substrate support 910 may surround all surfaces of the substrate 920. In this case, the substrate support 910 may be configured as a case or housing that accommodates the substrate 920.

The substrate support 910 supports the filter frame 120 and may be disposed on the lower side of the filter frame 120. In addition, the substrate support 910 may be disposed below the flow path module 200 and the valve module 800 to support at least one of the flow path module 200 and the valve module 800. Further, the substrate support 910 may be formed of a rigid plastic material, such as an engineering plastic or a glass containing plastic.

The substrate support 910 may include substrate support portions 911 and 912, an engaging part 913, and a coupling part 914.

The substrate support portions 911 and 912 are portion that support the substrate 920. When a plurality of substrates 920 are provided, the substrate support portions 911 and 912 may be provided in a number corresponding to the number of substrates 920. For example, when the substrate 920 is provided as a first substrate 921 and a second substrate 922, the substrate support portions may include a first substrate support portion 911 and a second substrate support portion 912.

The first substrate support portion 911 is the portion that supports the first substrate 921 and may be positioned higher than the second substrate support portion 912. In addition, the first substrate support portion 911 may have a larger area than the second substrate support portion 912. The first substrate support portion 911 has a peripheral wall formed to surround the first substrate 921 to prevent water from entering its peripheral surface.

The second substrate support portion 912 is the portion that supports the second substrate 922 and may be positioned lower than the first substrate support portion 911. In addition, the second substrate support portion 912 may have a smaller area than the first substrate support portion 911, and a rear surface of the second substrate support portion 912 may be disposed further to the rear than a rear surface of the first substrate support portion 911. The second substrate support portion 912 has a peripheral wall formed to surround the second substrate 921 to prevent water from entering its peripheral surface. A partition wall may be provided between the first substrate support portion 911 and the second substrate support portion 912 to separate the first substrate support portion 911 and the second substrate support portion 912.

The engaging part 913 can selectively engage with the base frame 130. The engaging part 913 may be provided at a lower portion of the substrate support 910 and may be provided at the rear surface of the substrate support 910. The engaging part 913 and the engaged part 131 may have a hook and groove shape so that one can be selectively engaged with the other. For example, a lower surface of the engaging part 913 may have a groove shape, and the rear side of the groove may be engaged with the engaged part 131 of the base frame 130. The engaged part 131 may have a hook shape that is engaged with a rear surface of the groove of the engaging part 913. A forwardly inclined reinforcing rib may be provided at an upper portion of the engaging part 913.

The coupling part 914 may be provided at the upper side of the substrate support portions 911 and 912 to be coupled with the fixing part 123 at the lower side of the filter frame 120. The coupling part 914 may be shaped to be inserted into the fixing part 123. A screw hole may be formed in the coupling part 914 to allow screw fastening with the fixing part 123.

The substrate 920 may include a controller that controls one or more of the water body 300, the heat dissipation unit 500, the fan unit 600, the opening and closing of the valve module 800, the power supply device 700, and the heating device 1000, and may be electrically connected to one or more of them. The controller may be implemented by a computing device including a microprocessor, a measuring device such as a sensor, and a memory, and the implementation method thereof is obvious to those skilled in the art, so a detailed description thereof is omitted.

A plurality of substrates 920 may be provided. The plurality of substrates 920 may include the first substrate 921 and the second substrate 922. The first substrate 921 may be electrically connected to the valve module 800 and may be smaller in size than the second substrate 922. The second substrate 922 may be electrically connected to the heating device 1000.

The heating device 1000 can heat the water filtered by the filter 20 to a predetermined temperature. For example, the heating device 1000 can heat the water filtered by the filter 20 to a temperature close to 100° C. In this case, the pressure inside the heating device 1000 may increase due to the heated water vapor.

Hereinafter, the operation and effects of the water purifier assembly 1 according to one embodiment of the present disclosure will be described.

In the water purifier assembly 1 according to one embodiment of the present disclosure, the substrate assembly 900 is disposed at the lower front side in the water purifier to support the load caused by the components disposed at the upper front side in the water purifier 10. The substrate assembly 900 acts as an intermediate frame, which enhances the rigidity of the water purifier 10 to withstand the load and impact. In particular, when the water purifier 10 has an overall shape in which the front part is recessed toward the rear to increase the convenience of a user (when the water purifier 10 has the shape of the alphabet “r” as viewed from the side, as shown in FIG. 4), the substrate assembly 900 is disposed at the lower front side in the water purifier 10 to support the load of the components disposed above the water dispensing unit 210, so that it is possible to prevent the case from being deformed and the components from being displaced from their correct positions, even without separately reinforcing the rigidity of the frame or case.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A water purifier comprising:
a frame configured to accommodate a filter for filtering water;
a flow path module providing a passage for the water to flow and disposed at an upper portion in the frame;
a valve module selectively opened and closed to control the flow of water in the flow path module and disposed at a position adjacent to the flow path module; and
a substrate assembly for controlling an opening and closing of the valve module,
wherein the substrate assembly includes:
at least one substrate electrically connected to the valve module; and
a substrate support covering at least a portion of the substrate and coupled to the frame to support the at least one substrate, and
wherein the substrate support is disposed below the flow path module and the valve module and supports at least one of the flow path module and the valve module.

2. The water purifier of claim 1, further comprising a water body into which the water is introduced,
wherein the flow path module, the valve module, and the substrate assembly are disposed forward of the water body.

3. The water purifier of claim 1, wherein the frame includes a filter frame in which the filter is installed and which supports at least one of the flow path module and the valve module, and
the substrate support supports the filter frame and is positioned below the filter frame.

4. The water purifier of claim 3, wherein the filter frame includes:
a frame body in which the filter is installed; and
a supporter extending forward from the frame body and supporting at least one of the flow path module and the valve module.

5. The water purifier of claim 3, wherein the substrate support includes a coupling part which is coupled to the filter frame,
the coupling part is provided at an upper portion of the substrate support, and
the filter frame includes a fixing part provided to surround an upper surface and side surfaces of the coupling part when the coupling part is coupled to the filter frame.

6. The water purifier of claim 1, wherein the frame includes a base frame which has an engaged part formed to be engaged with the substrate support and supports the substrate support,
the substrate support includes an engaging part which selectively engages with the engaged part,
the engaging part is provided at a lower portion of the substrate support, and
the engaged part and the engaging part are provided in a hook and groove shape so that one of them is selectively engaged with the other.

7. The water purifier of claim 1, further comprising;
a heating device for heating the water to a predetermined temperature,
wherein the at least one substrate includes:
a first substrate electrically connected to the valve module; and
a second substrate electrically connected to the heating device.

8. The water purifier of claim 1, wherein a width of the substrate assembly in a left and right direction is greater than a width of the substrate assembly in a front and rear direction.

9. A water purifier assembly comprising:
a filter for filtering water to provide purified water; and
a water purifier in which the filter is detachably installed,
wherein the water purifier includes:
a frame configured to accommodate the filter;
a flow path module providing a passage for the water to flow and disposed at an upper portion in the frame;
a valve module selectively opened and closed to control the flow of water in the flow path module and disposed at a position adjacent to the flow path module; and
a substrate assembly for controlling an opening and closing of the valve module,
wherein the substrate assembly includes:
at least one substrate electrically connected to the valve module; and
a substrate support covering at least a portion of the substrate and coupled to the frame to support the at least one substrate, and
wherein the substrate support is disposed below the flow path module and the valve module and supports at least one of the flow path module and the valve module.

10. The water purifier assembly of claim 9, wherein the frame includes a filter frame in which the filter is installed and which supports at least one of the flow path module and the valve module, and
wherein the substrate support supports the filter frame.
